(19) United States
(12) Patent Application Publication
(10) Pub. No.: US 2009/0063417 A1
(43) Pub. Date: Mar. 5, 2009

(54) Index attribute subtypes for LDAP entries

(76) Inventor: Nathan G. Kinder, Castro Valley, CA (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/897,463

(22) Filed: Aug. 30, 2007

(51) Int. Cl. G06F 17/30

(52) U.S. Cl. 707/3; 707/E17.014

(57) ABSTRACT

A method and apparatus for indexing attribute subtypes for Light Weight Directory Access Protocol (LDAP) entries. In one embodiment, the method includes receiving a query specifying a search criterion for a subtype of a base attribute. The base attribute and the subtype are associated with LDAP entries. The method also includes determining a response to the query by looking up a subtype index that points to the LDAP entries having a presence of the subtype.

### TECHNICAL FIELD

Embodiments of the present invention relate to Lightweight Directory Access Protocol (LDAP), and more specifically, to index the presence of a subtype associated with LDAP entries.

### BACKGROUND

Light Weight Directory Access Protocol (LDAP) has become very popular due to its efficient and fast data access. A large number of applications/services are currently being developed which use an LDAP directory as their centralized data repository.

An LDAP directory stores data as entries, with each entry identified by a distinguished name (DN). An LDAP entry includes a collection of key/value pairs. A key/value pair may consist of an attribute name and an attribute value. For example, an entry representing a person may include the textual string “telephoneNumber” as the attribute name and the numeric string “+1 800 123 4567” as the attribute value. An attribute (also referred to as a base attribute) may be further specialized through subtypes. For example, “language” and “title” may be subtypes of the base attribute “common name.”

An LDAP directory can be searched to provide information of an LDAP entry. To facilitate the search, index files are sometimes created to enable a fast lookup. Currently, LDAP entries are indexed by their base attribute values. The base attribute index files are created without taking into account that a subtype is used. An entry having a subtype is indexed just as it is for the base attribute. Thus, a search using a subtype in an LDAP directory is potentially inefficient and time-consuming.

### BRIEF DESCRIPTION OF THE DRAWINGS

The present invention is illustrated by way of example, and not by way of limitation, in the figures of the accompanying drawings and in which:

FIG. 1 illustrates a network architecture in which embodiments of the present invention may be implemented.

FIG. 2 is a block diagram of a Light Weight Directory Access Protocol (LDAP) directory server coupled to an LDAP repository where subtype indices are stored.

FIG. 3 is a flow diagram of one embodiment of a process that performs searches in response to a search request.

FIG. 4 is a flow diagram of one embodiment of a process that updates the subtype indices.

FIG. 5 illustrates a block diagram of an exemplary computer system implementing some embodiments of the present invention.

### DETAILED DESCRIPTION

Described herein is a method and apparatus for indexing attribute subtypes for Light Weight Directory Access Protocol (LDAP) entries. In one embodiment, subtype indices are created to identify the LDAP entries having the presence of particular subtypes. Each subtype index is created for a subtype associated with a base attribute, and includes a list of identifiers that point to the LDAP entries having the subtype present. A subtype is considered present in an LDAP entry if the entry has a non-null value associated with the subtype. Using the subtype indices, a directory server can quickly determine the entries that have the subtype and disregard those that do not have the subtype. This allows the directory server to avoid retrieving a potentially large number of candidates, many of which do not even have the subtype specified in a query. Thus, search performance can be improved.

In some embodiments, a directory server can use the subtype indices in tandem with the regular base attribute indices to find an intersection of entries. A base attribute index includes a list of identifiers that identify all of the LDAP entries that have the base attribute present. Additionally, a base attribute index indexes the LDAP entries by their base attribute values. A base attribute index includes the base attribute values of the LDAP entries and arranges the entries in an order that is easy to search. For example, the base attribute index for “name” may order the values (a textual string) of the names by alphabetical order. In response to a query that requests the information of a person named “John” in the English language, the directory server may look for a first group of entries having the name attribute in English, and a second group of entries having the name attribute equal to “John” (regardless of languages). The intersection of the two groups of entries produces the results of the search.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “updating”, “creating”, “receiving”, “determining”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

A machine-accessible storage medium includes any mechanism for storing or transmitting information in a form readable by a machine (e.g., a computer). For example, a machine-accessible storage medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

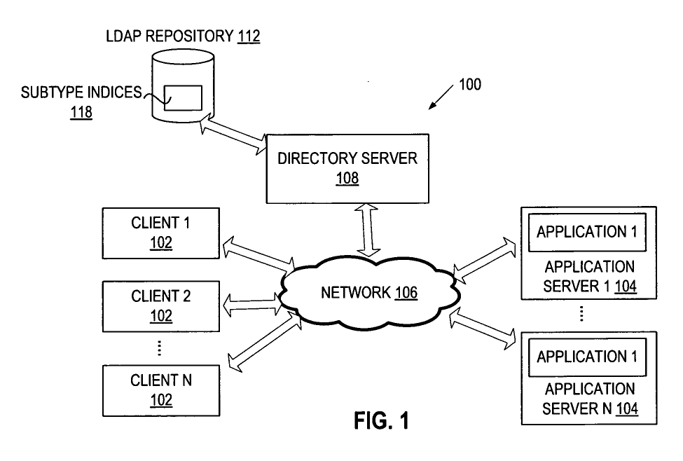

FIG. 1 illustrates an exemplary network architecture 100 in which embodiments of the present invention may operate. The network architecture 100 may include client devices (clients) 102, a directory server 108 and a network 106. The clients 102 may be, for example, personal computers (PCs), mobile phones, palm-sized computing devices, personal digital assistants (PDAs), and the like.

In one embodiment, the directory server 108 may be a Light Weight Directory Access Protocol (LDAP) directory server. The directory server 108 may contain a server front end responsible for network communications, plugins for server functions (such as access control and replication), a basic directory tree containing server-related data, and a database back end plugin responsible for managing the storage and retrieval of repository data.

The clients 102 are coupled to the directory server 108 via the network 106, which may be a public network (e.g., Internet) or a private network (e.g., Ethernet or a local area Network (LAN)). In one embodiment, the clients 102 communicate with the directory server 108 via a web server (not shown). For example, the clients 102 may host web browsers that communicate with the web server using HTTP to request information. The web server may then communicate with the directory server 108 to retrieve requested information from a data repository 112. Alternatively, the clients 102 may communicate directly with the directory server 108 to request information stored in the data repository 112.

The network architecture 100 may also include one or more application servers 104 that host various applications requesting information from the directory server 108. The application servers 104 operate as clients in communication with the directory server 108. Similarly to the clients 102, the application servers 104 may communicate with the directory server 108 directly or via a web server.

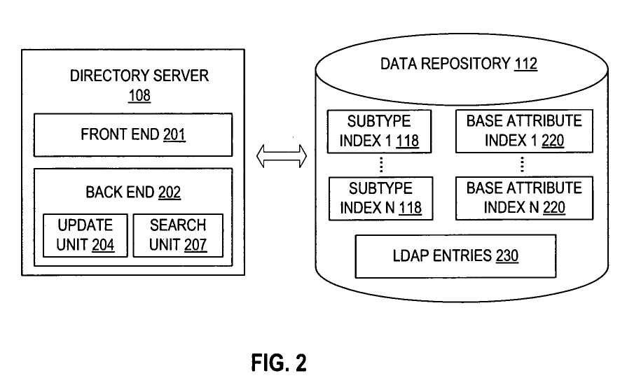

The data repository 112 may be part of the directory server 108, or it may reside externally (e.g., on a database server). The data repository 112 may contain a tree of LDAP entries, each of which includes base attribute names and attribute values. Base attributes may be further specialized through subtypes. For example, “language” and “title” may be subtypes of the base attribute “common name.” When performing a search of the data repository 112, a search request may specify the base attribute to retrieve data entries with all subtypes of this base attribute, or it may specify a certain subtype, in addition to the base attribute, to retrieve only data entries that match the specified subtype of the base attribute. In an embodiment, the data repository 112 stores one or more attribute index files 118 to facilitate searches. The attribute index files 118 will be described in greater detail below with reference to FIG. 2.

FIG. 2 illustrates an embodiment of the directory server 108 and the data repository 112. The directory server 108 includes a front end 201 and a back end 202. The front end 201 determines the type of an incoming request (e.g., a search request or an update). If the request is a search request, the front end 201 identifies a base attribute, a subtype of a base attribute (if any), and a search criterion specified in the search request.

After the front end 201 identifies the request type, the parsed information is passed to the back end 202. The back end 202 of the directory server 108 includes an update unit 204 to perform update operation to the LDAP entries 230, and a search unit 207 to perform query operations. The back end 202 is to return retrieved values to a network interface for transmitting a reply to the requester.

In one embodiment, the data repository 112 stores the attribute index files 118 to facilitate searches of the LDAP entries 230. In alternative embodiments, the attribute index files 118 may be stored in the main memory or other memory devices accessible to the directory server 108. Each attribute index file 118 stores information of a base attribute and one or more subtypes associated with the base attribute. The information of the base attribute is stored in a base attribute index 220 and the information of the subtypes associated with the base attribute is stored in subtype indices 250. Each subtype index 250 may be identified by the name of the subtype and the name of its associated base attribute. Each subtype index 250 includes a list of identifiers that identify the LDAP entries having a presence of the subtype associated with the base attribute. For example, the subtype index for “mail;en_us” may include a list of the LDAP entries having non-null values defined for “mail;en_us”. In one embodiment, the list of identifiers may be pointers that point to the storage or memory locations of the LDAP entries.

The base attribute indices 220 may be identified by the base attribute name. Each base attribute index 220 includes a list of identifiers that identify the LDAP entries that have the base attribute present, regardless of whether the base attribute is associated with a subtype. Additionally, each base attribute index 220 includes the base attribute values of the LDAP entries and arranges the entries in an order that is easy to search. For example, the base attribute index 220 for “mail” may include the identifiers of all of the LDAP entries that contain an email address, and those identifiers may be arranged according to the alphabetical order of their email addresses.

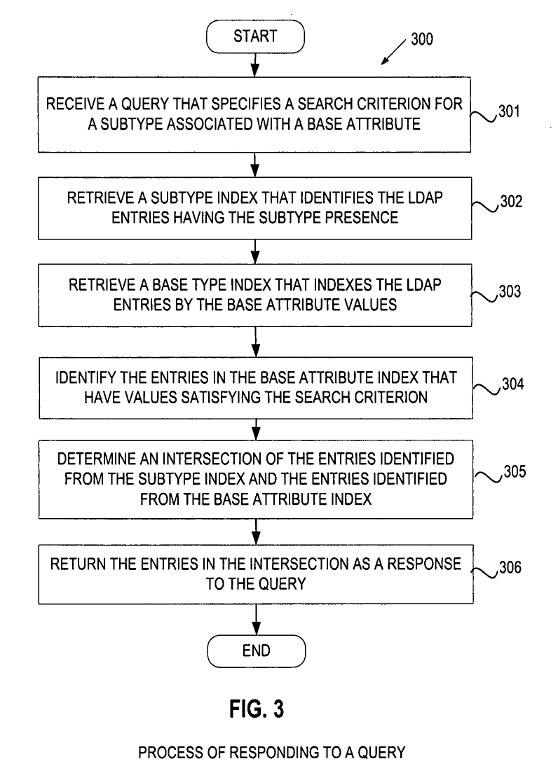

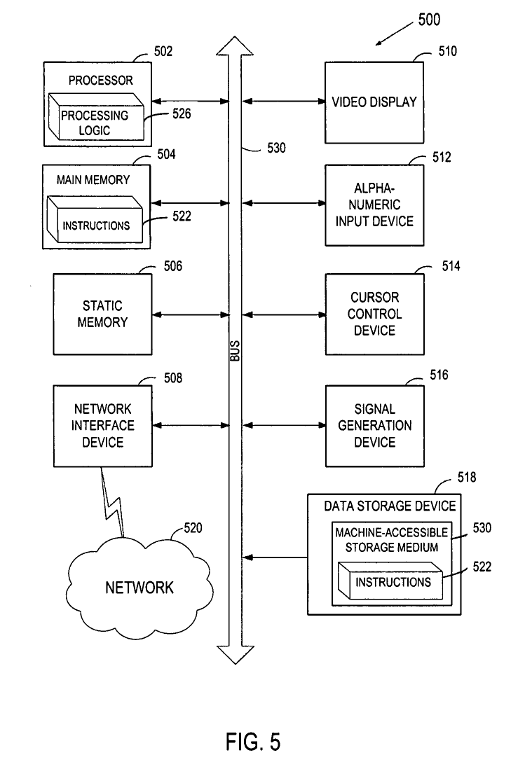

FIG. 3 illustrates a flow diagram of one embodiment of a process 300 for processing a request for a value of an LDAP entry. The process 300 may be performed by processing logic 526 of FIG. 5 that may comprise hardware (e.g., circuitry, dedicated logic, programmable logic, microcode, etc.), software (such as instructions run on a processing device), or a combination thereof. In one embodiment, the process 300 is performed by the directory server 108 of FIG. 1 and FIG. 2.

Referring to FIG. 3, at block 301, the process 300 begins with the processing logic 526 receiving a query for an LDAP entry. In one embodiment, the query specifies a search criterion for a subtype associated with a base attribute. For example, the query may include “mail;en_us=smith*”, where “mail” is a base attribute for an email address of a person, “en_us” is a subtype of the mail attribute indicating the English language, “=” is a relational operator specified in the search criterion, and “smith*” is a query value specified in the search criterion. The relational operator and the query values are defined compliant with the LDAP protocol. That is, the relational operator may be “=”, “>”, “<”, “≦”, “≧” or the like. The query value may be a string, a substring (a string including a wild card), a wild card (indicating a presence), or the like.

Continuing to block 302, the processing logic 526 retrieves one of the subtype indices 250 for the subtype and the base attribute specified in the query. The subtype index 250 includes a list of identifiers that identify the LDAP entries having a presence of the subtype. In the above example, the identifiers for all the LDAP entries 230 having a non-null value for “mail;en_us” are determined. At block 303, one of the base attribute indices 220 is retrieved for the base attribute specified in the query. In the above example, the LDAP entries 230 having a non-null value for “mail” are identified. At block 304, the query value is compared with the base attribute values in the base attribute index 220 for “mail” to determine whether any of the LDAP entries has a value that satisfies the search criterion “value=smith*”. That is, the LDAP entries that have their email addresses starting with “smith” are identified. As discussed above with reference to FIG. 2, some of the entries identified by the base attribute index 220 may have email addresses starting with “smith” in a non-English language (e.g., French, German, etc.); therefore, these email addresses may be associated with a subtype different from “en_us”.

Subsequently, at block 305, the entries identified at block 302 are compared with the entries identified at block 304 to determine an intersection of entries. The entries in the intersection are the LDAP entries that both have the specified subtype present for the specified base attribute, and have the base attribute values satisfying the search criterion. At block 306, the entries in the intersection are retrieved from the data repository 112. At block 307 the retrieved entries are returned as a result of the query.

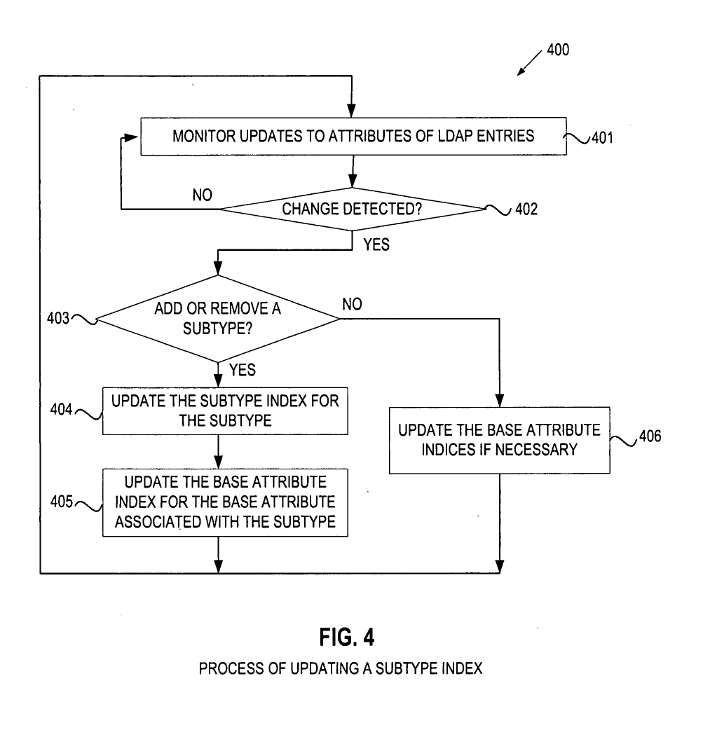

FIG. 4 illustrates a flow diagram of one embodiment of a process 400 for processing a request for updating the LDAP entries. The process 400 may be performed by processing logic 526 of FIG. 5 that may comprise hardware (e.g., circuitry, dedicated logic, programmable logic, microcode, etc.), software (such as instructions run on a processing device), or a combination thereof. In one embodiment, the process 400 is performed by the directory server 108 of FIG. 1 and FIG. 2.

Referring to FIG. 4, at block 401, the process 400 begins with the processing logic 526 monitoring updates to the LDAP entries. Upon detection of a change at block 402, it is further determined, at block 403, whether the change is an addition, removal, or medication of a subtype. An addition/removal of a subtype occurs when an existing subtype is added to or removed from a base attribute of an LDAP entry, when a new subtype is created and added to an LDAP entry, or when any operation is performed to change the presence of a subtype in the LDAP entries. A subtype is modified when the value of the subtype is changed. If an addition/removal/modification of a subtype is detected, at block 404, the corresponding subtype index 250 is updated to reflect a change in the subtype presence. At block 405, the base attribute index 220 associated with the subtype is also updated to reflect a change to the base attribute values associated with the subtype. The process 400 then loops back to block 401 to continue monitoring updates to the attributes of the LDAP entries.

If, at block 403, it is determined that the change is not an addition, a removal, or a modification of a subtype, at block 406, the base attribute indices 220 are updated if necessary. For example, subtype indices 250 do not need updates if a change is made to a base attribute not associated with any subtypes. After the update, the process 400 loops back to block 401 to continue monitoring updates to the attributes of the LDAP entries.

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processing device 502 represents one or more general-purpose processing devices such as a microprocessor, central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute the processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-accessible storage medium 530 on which is stored one or more sets of instructions (e.g., software 522) embodying any one or more of the methodologies or functions described herein. The software 522 may also reside, completely or at least partially, within the main memory 504 and/or within the processing device 502 during execution thereof by the computer system 500, the main memory 504 and the processing device 502 also constituting machine-accessible storage media. The software 522 may further be transmitted or received over a network 520 via the network interface device 508.

The machine-accessible storage medium 530 may also be used to store the LDAP entries 230 of FIG. 2. While the machine-accessible storage medium 530 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

Thus, a method and system for indexing attribute subtypes for LDAP entries have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A computer-implemented method comprising:
receiving a query specifying a search criterion for a subtype of a base attribute, the base attribute and the subtype associated with Light Weight Directory Access Protocol (LDAP) entries; and
determining a response to the query by looking up a subtype index that points to the LDAP entries having a presence of the subtype.

2. The method of claim 1, wherein determining a response further comprises:
determining an intersection of first entries and second entries in response to the query, the first entries identified from the subtype index, the second entries identified from a base attribute index that indexes the LDAP entries by values of the base attribute.

3. The method of claim 1, further comprising:
updating the subtype index to indicate that the subtype has been added to or removed from one of the LDAP entries.

4. The method of claim 1, further comprising:
creating the subtype index on the fly following addition of the subtype in one of the LDAP entries.

5. The method of claim 1, wherein the subtype index includes pointers that point to locations of the LDAP entries having the subtype present.

6. The method of claim 1, wherein the search criterion further includes a relational operator, the second entries including the LDAP entries that have the values of the base attribute satisfying the search criterion with respect to the relational operator.

7. The method of claim 1, further comprising:
creating a plurality of subtype indices for the base attribute, each of the subtype indices identified by a subtype name and a base attribute name.

8. A system comprising:
a repository to store Light Weight Directory Access Protocol (LDAP) entries; and
a directory server coupled to the repository to maintain a subtype index that identifies the LDAP entries having a presence of a subtype associated with a base attribute, and to look up the subtype index in response to a query that specifies a search criterion for the subtype.

9. The system of claim 8, wherein the directory server further comprises:
a front end to receive the query; and
a back end coupled to the front end and the repository to determine, in response to the query, an intersection of first entries identified by the subtype index and second entries that have values of the base attribute satisfying the search criterion.

10. The system of claim 8, wherein the directory server further comprises:
an update unit to update the subtype index to indicate that the subtype has been added to or removed from one of the LDAP entries.

11. The system of claim 8, wherein the directory server creates and updates the subtype index on the fly.

12. The system of claim 8, wherein the directory server maintains the subtype index to includes pointers that point to locations of the LDAP entries having the subtype present.

13. The system of claim 8, wherein the directory server maintains a plurality of subtype indices for the base attribute, each of the subtype indices identified by a subtype name and a base attribute name.

14. An article of manufacture, comprising:
a machine-accessible storage medium including data that, when accessed by a machine, cause the machine to perform a method comprising:
receiving a query specifying a search criterion for a subtype of a base attribute, the base attribute and the subtype associated with Light Weight Directory Access Protocol (LDAP) entries; and
determining a response to the query by looking up a subtype index that points to the LDAP entries having a presence of the subtype.

15. The article of manufacture of claim 14, wherein determining a response further comprises:
determining an intersection of first entries and second entries in response to the query, the first entries identified from the subtype index, the second entries identified from a base attribute index that indexes the LDAP entries by values of the base attribute.

16. The article of manufacture of claim 14, wherein the method further comprises:
updating the subtype index to indicate that the subtype has been added to or removed from one of the LDAP entries.

17. The article of manufacture of claim 14, wherein the method further comprises:
creating the subtype index on the fly following addition of the subtype in one of the LDAP entries.

18. The article of manufacture of claim 14, wherein the subtype index includes pointers that point to locations of the LDAP entries having the subtype present.

19. The article of manufacture of claim 14, wherein the query further includes a relational operator, the second entries including the LDAP entries that have the values of the base attribute satisfying the search criterion with respect to the relational operator.

20. The article of manufacture of claim 14 wherein the method further comprises:
creating a plurality of subtype indices for the base attribute, each of the subtype indices identified by a subtype name and a base attribute name.
